(19) United States
(12) Patent Application Publication
(10) Pub. No.: US 2024/0160942 A1
(43) Pub. Date: May 16, 2024

(54) METHOD AND ELECTRONIC SYSTEM FOR A NON-ITERATIVE TRAINING OF A NEURAL NETWORK

(71) Applicant: Universitat de les Illes Balears, Palma de Mallorca (ES)

(72) Inventors: Fabio GALÁN PRADO, Palma de Mallorca (ES); Jose Luis ROSSELLÓ SANZ, Palma de Mallorca (ES)

(73) Assignee: Universitat de les Illes Balears, Palma de Mallorca (ES)

(21) Appl. No.: 18/282,323

(22) PCT Filed: Mar. 14, 2022
(86) PCT No.: PCT/EP2022/056497

§ 371 Date: Sep. 15, 2023

(30) Foreign Application Priority Data
Mar. 15, 2021 (ES) P202130225

(51) Int. Cl. G06N 3/091; G06F 7/544; G06F 17/16

(52) U.S. Cl. CPC G06N 3/091; G06F 7/5443; G06F 17/16

(57) ABSTRACT

Method and Electronic system for non-iterative training of a neural network, based on training data including an input data matrix and an output data matrix, the output data matrix being expected for said input data matrix, the training resulting in a matrix of weights of the neural network.

The present application claims the benefit of Spanish Patent Application P202130225 filed Mar. 15, 2021.

### FIELD OF THE INVENTION

The present disclosure relates to methods and electronic systems for non-iterative training of a neural network.

### BACKGROUND

Even though the scale of microelectronic components has continued to decrease in recent years, the amount of calculation performed within devices and computer servers has increased substantially, especially in the field of artificial intelligence. The implementation of AI processes within Internet of Things (IoT) systems, enable these systems to send high-level information directly to servers rather than raw data to servers. The result is a significant reduction in the cost of data transmission as well as in server load.

Among all the Machine Learning techniques currently in use, Artificial Neural Networks (ANNs) are particularly noteworthy, which are commonly used for implementation used to solve real-life problems, such as pattern recognition or time series prediction with great accuracy. Usually, ANNs are fully implemented in a software manner, but is in its direct hardware implementation in which the intrinsic parallelism of these systems can be exploited properly.

Therefore, the demand for new circuits incorporating Artificial Intelligence (AI) in an efficient way is on the rise. A current example of that is the use of traditional methodologies based on Von-Neumann type processors, which may not be efficient in terms of consumption and latency. Several companies have developed AI chips such as, for example, Intel, Amazon, Apple, Google, Ali Baba, Samsung, AMD, Qualcomm, Baidu or NVidia. However, these devices are usually inference-oriented, or implement learning through iterative algorithms (which are more expensive in terms of consumption and hardware than non-iterative training algorithms).

The computational core of most neural networks or signal processors is matrix multiplication. Because neural networks may be made up of a massive number of neurons, matrix operations become a problem because they do not scale linearly with the dimension of the matrices.

For all of the above, there is a great interest in designing specific hardware capable of performing training of a neural network in a simple and compact way. Although there have been attempts at solving this problem through different neural networks hardware implementations, most studies and designs have focused on the inference part of neural networks. There are also several works (for example, papers) on the study of the circuitry required for unsupervised training. However, in the case of supervised training, only partial and very theoretic solutions have been described, and, more specifically, there are no on-chip solutions that efficiently implement non-iterative supervised learning.

Therefore, there is a growing need of electronic systems, such as a plurality or single integrated circuits (IC) to implement different machine learning (ML) training techniques using less hardware and having less operation load (i.e which operate in an energy-efficient way).

### SUMMARY

According to a first aspect, a method of non-iterative training of a neural network is presented, the method being performed by an electronic system, based on training data including an input data matrix and an output data matrix, the output data matrix being expected for said input data matrix, wherein the output data matrix comprises a plurality of output vectors corresponding to each column of the output data matrix, the training resulting in a matrix of weights of the neural network, and wherein the method comprises the steps of:
a) Transposing the input data matrix;
b) Negating the elements within the transposed input data matrix;
c) Selecting a plurality of input vectors corresponding to each row of the transposed and negated input data matrix;
d) Generating a matrix of addition vectors, wherein each addition vector is the sum of:
   the input vector corresponding to the row of the input data matrix, said row corresponding to the row position of the addition vector; and
   the output vector corresponding to the column of the output data matrix, said column corresponding to the column position of the output vector;
e) Selecting, for each addition vector, a maximum or minimum value among the elements of the addition vector;
f) Generating a matrix of weights for the neural network, wherein each weight of the matrix is the selected maximum or minimum value of the vector found in the same position of the matrix of addition vectors as the position of the weight within the matrix of weights.

The use of the method of the present disclosure may minimize the cost of training neural networks in a non-iterative way by means of an electronics system, such as, for example, an integrated circuitry, by avoiding high-cost digital blocks, usually implemented by large numbers of logic gates, such as, for example, digital multipliers. This may be achieved by substituting the linear regressions methods (in conventional algebra) by the linear regression methods in max-plus algebra. This substitution enables to avoid any use of hardware consuming digital multipliers and Moore Penrose pseudoinverses when generating set of weights of a neural network, performed in a non-iterative training of the network. Such substitution may be implemented in a hardware manner.

The electronics system may comprise, for example at least one Field Programmable Gate Array (FPGA), at least one Application-Specific Integrated Circuit (ASIC), or at least one programmable electronic device such as a CPLD (Complex Programmable Logic Device). More specifically, the electronics system may also be a combination of an FPGA, an ASIC, and/or a CPLD, wherein certain modules may be comprised spread out among any of said types of systems.

More specifically, supervised non-iterative training of neural networks such as Reservoir Computing (RC) systems, Extreme Learning machines (ELMs), or those in which only the output layer is trained, may involve having to solve a system of linear equations, in conventional algebra, in the following manner:

A*X=B

Wherein, in a generic way:
A may be a two-dimensional input data matrix;
X may be a two-dimensional weight data matrix; and
B may be a two-dimensional output data matrix;

And wherein each element of each data matrix comprises data encoded in binary code.

In the training process of neural networks, matrix A may represent the activity of the neurons in the network, i.e., a set of input data which may be used to train the network. On the other hand, B may represent the reference pattern against which the network may be trained, for example, a set of categories in which the neural network categorizes any given input. In this case, in order to train the neural network, the data found within matrix B is paired with the data found in matrix A. Finally, matrix X comprises the weights that would fit the output of the network (i.e., the data within matrix B) to the referenced input data (i.e., the data within matrix A).

Therefore, according to this disclosure, in the training process of neural networks, the previous equation, A*X=B, would be read as matrix A being operated on matrix X (in conventional algebra, a matrix multiplication of A and X), resulting in matrix B. Generically, in a neural network, this may be interpreted as the network input (data within matrix A) being transformed into the expected output of the neural network (data within matrix B), by operating said input with the weight matrix (weights within matrix X), the weight matrix X being previously obtained by a training process.

At this point, in order to obtain the weight matrix X, the Moore Penrose pseudo inverse may be calculated. Such operation would be very difficult to be implemented in hardware, since determinants of big data matrices may have to be calculated, which would require a very high amount of hardware resources. Furthermore, such operation would also require the use of large digital multipliers.

In order to avoid the calculation of Moore Penrose pseudo inverses and the use of digital multipliers, the previously mentioned substitution may be performed. More specifically, the conventional algebra system of linear equations may be substituted by a system of linear equations within max-plus algebra.

In order to perform this substitution, an idempotent analysis may be applied. Such analysis substitutes the conventional algebra linear system, by an equivalent linear system within tropical semirings. A tropical semiring may be a semiring of extended real numbers with the operations of maximum (selection of the greater) and addition, replacing the usual (conventional algebra) operations of addition and multiplication, respectively.

In the case of the maximum replacing the conventional algebra addition and the addition replacing the conventional algebra multiplication (the commonly known Max-plus semiring of Tropical algebra), the following operations may be defined by the following max-plus semiring (note: any lower-case letter, like, for example, a and b may represent generic scalars; and any upper-case letter, like, for example, A and B, may represent matrices):

a⊕b=max(a,b)

a⊗b=a+b

Wherein a max-plus sum equals to the selection of the greater among the elements being summed, in max-plus algebra, and wherein a max-plus multiplication equals to the sum of the elements being multiplied in max-plus algebra.

The following may also be applied to matrix operations (note: sub index in generic matrices such as A, B or C describe only, as additional information, the dimensions the corresponding matrix):

A_{m×n}⊕B_{m×n}=C_{m×n}→cᵢⱼ=aᵢⱼ⊕bᵢⱼ=max(aᵢⱼ,bᵢⱼ)

A_{m×n}⊗B_{n×l}=C_{m×l}→cᵢⱼ=⊕ₖ₌₁^{k=n}(aᵢₖ⊗bₖⱼ)=max(aᵢ₁+b₁ⱼ,aᵢ₂+b₂ⱼ, . . . ,aᵢₙ+bₙⱼ)

Wherein “max” denotes selecting the maximum value of the accompanying vector.

In order to solve the max-plus linear system of equations, the following dual operations may be defined:

a⊕′b=min(a,b)

a⊗′b=a⊗b=a+b

A_{m×n}⊕′B_{m×n}=C_{m×n}→cᵢⱼ=aᵢⱼ⊕′bᵢⱼ=min(aᵢⱼ,bᵢⱼ)

A_{m×n}⊗′B_{n×l}=C_{m×l}→cᵢⱼ=⊕′ₖ₌₁^{k=n}(aᵢₖ⊗bₖⱼ)=min(aᵢ₁+b₁ⱼ,aᵢ₂+b₂ⱼ, . . . ,aᵢₙ+bₙⱼ)

Therefore, the previously described idempotent analysis may be applied to the following equation:

A⊗X=B

In order to generate the weight of the neural network, the following may be applied:

A_{m×n}⊗(A*_{n×m}⊗′B_{m×l})≤B_{m×l}≤A_{m×n}⊗′(A*_{n×m}⊗B_{m×l})

A_{m×n}⊗X̅ₘᵢₙ_{_{n×l}}≤B_{m×l}≤A_{m×n}⊗′X̅ₘₐₓ_{_{n×l}}

\hat{B}ₘᵢₙ_{_{m×l}}≤B_{m×l}≤\hat{B}ₘₐₓ_{_{m×l}}

Wherein A*=−A^{T} and −A^{T} may be the input data matrix A negated and transposed.

The previous expression shows that by choosing the minimum when generating the weights of the neural network, X̅ₘᵢₙ, the resulting approximation, \hat{B}ₘᵢₙ, may be less than or equal to the output matrix B. Alternatively, by choosing the maximum when generating the weights of the neural network X̅ₘₐₓ, the resulting approximation, \hat{B}ₘₐₓ, may be greater than or equal to the output matrix B. Therefore, both alternatives, found within the max-plus semiring, may be used to generate the matrix of weights of the neural network.

The calculations of the weights of the neural network, by applying the previously described idempotent analysis may be expanded as follows:

$${\overline{X}}_{{min}_{NxK}} = {( - {A}_{LxN} )}^{T} {⊗}^{′} {B}_{LxK} = {A}_{LxN}^{*} {⊗}^{′} {B}_{LxK} = = - {( \begin{matrix}{a}_{11} & ⋯ & {a}_{1 N} \\ ⋮ & ⋱ & ⋮ \\ {a}_{L 1} & ⋯ & {a}_{LN}\end{matrix} )}^{T} {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = = {( \begin{matrix}- {a}_{11} & ⋯ & - {a}_{1 N} \\ ⋮ & ⋱ & ⋮ \\ - {a}_{L 1} & ⋯ & - {a}_{LN}\end{matrix} )}^{T} {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = = ( \begin{matrix}{a}_{11}^{*} & ⋯ & {a}_{1 L}^{*} \\ ⋮ & ⋱ & ⋮ \\ {a}_{N 1}^{*} & ⋯ & {a}_{NL}^{*}\end{matrix} ) {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = {A}_{LxN}^{*} {⊗}^{′} {B}_{LxK} = = min ( \begin{matrix}{\vec{x}}_{11}^{*} & ⋯ & {\vec{x}}_{1 K}^{*} \\ ⋮ & ⋱ & ⋮ \\ {\vec{x}}_{N 1}^{*} & ⋯ & {\vec{x}}_{NK}^{*}\end{matrix} ) = min {\overline{X}}_{NxK}^{*} = ( \begin{matrix}{\overline{x}}_{11} & ⋯ & {\overline{x}}_{1 K} \\ ⋮ & ⋱ & ⋮ \\ {\overline{x}}_{N 1} & ⋯ & {\overline{x}}_{NK}\end{matrix} ) = {\overline{X}}_{{min}_{NxK}}$$

$${\overline{X}}_{{max}_{NxK}} = {( - {A}_{LxN} )}^{T} {⊗}^{′} {B}_{LxK} = {A}_{LxN}^{*} {⊗}^{′} {B}_{LxK} = = - {( \begin{matrix}{a}_{11} & ⋯ & {a}_{1 N} \\ ⋮ & ⋱ & ⋮ \\ {a}_{L 1} & ⋯ & {a}_{LN}\end{matrix} )}^{T} {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = = {( \begin{matrix}- {a}_{11} & ⋯ & - {a}_{1 N} \\ ⋮ & ⋱ & ⋮ \\ - {a}_{L 1} & ⋯ & - {a}_{LN}\end{matrix} )}^{T} {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = = ( \begin{matrix}{a}_{11}^{*} & ⋯ & {a}_{1 L}^{*} \\ ⋮ & ⋱ & ⋮ \\ {a}_{N 1}^{*} & ⋯ & {a}_{NL}^{*}\end{matrix} ) {⊗}^{′} ( \begin{matrix}{b}_{11} & ⋯ & {b}_{1 K} \\ ⋮ & ⋱ & ⋮ \\ {b}_{L 1} & ⋯ & {b}_{LK}\end{matrix} ) = {A}_{LxN}^{*} {⊗}^{′} {B}_{LxK} = = max ( \begin{matrix}{\vec{x}}_{11}^{*} & ⋯ & {\vec{x}}_{1 K}^{*} \\ ⋮ & ⋱ & ⋮ \\ {\vec{x}}_{N 1}^{*} & ⋯ & {\vec{x}}_{NK}^{*}\end{matrix} ) = max {\overline{X}}_{NxK}^{*} = ( \begin{matrix}{\overline{x}}_{11} & ⋯ & {\overline{x}}_{1 K} \\ ⋮ & ⋱ & ⋮ \\ {\overline{x}}_{N 1} & ⋯ & {\overline{x}}_{NK}\end{matrix} ) = {\overline{X}}_{{max}_{NxK}}$$

Wherein X̅ may be the matrix of weights of the neural network, matrix A may be the input matrix and matrix B may be the output matrix, each having the correspondent dimensions as specified by the exemplary subindexes.

Therefore, the elements “a” of matrix A are rearranged by negating and transposing matrix A, thus turning matrix A into a new matrix A* comprising elements “a*”, which may be multiplied using the multiplication substitution of the max-plus semiring.

Said new matrix of “a*” elements is obtained by performing steps a) of transposing the input data matrix (matrix A in the previous equations), and step b) of negating the elements within the transposed input data matrix.

Then, the substitution of the multiplication of two matrixes using the max plus semiring would follow the specific equation:

x̅ₘᵢₙ_{ₙₖ}=⊕′(−aₗₙ⊗bₗₖ)=min(−a₁ₙ+b₁ₖ,−a₂ₙ+b₂ₖ, . . . ,−a_{Ln}+b_{Lk})

x̅ₘₐₓ_{ₙₖ}=⊕(−aᵢₙ⊗bₗₖ)=max(−a₁ₙ+b₁ₖ,−a₂ₙ+b₂ₖ, . . . ,−a_{Ln}+b_{Lk})

Wherein a resulting vector \vec{x}*ₙₖ=(−a₁ₙ+b₁ₖ, −a₂ₙ+b₂ₖ, . . . , −a_{Ln}+b_{Lk}) may be an addition vector.

Therefore, the selection of each sum of vectors may be performed by selecting each row of the new matrix A*, and summing it with each column of output matrix B, each resulting vector (named herein “addition vector”) being placed within a resulting matrix X̅*_{N×K}. The resulting matrix X̅*_{N×K} comprises, in each of its positions (position defined by X* row and Y* column), the resulting addition vector of adding the vector of the corresponding X* row from matrix A*, and the vector of the corresponding Y* column from matrix B.

More precisely, generation of matrix X̅*_{N×K} may be performed by the following steps of the method of the present disclosure:
a) Selecting a plurality of input vectors corresponding to each row of the transposed and negated input data matrix (i.e., the rows of matrix A*);
b) Generating a matrix of addition vectors (i.e., matrix X̅*_{NX}K), wherein each addition vector (in the above equations, each addition vector (\vec{x}*ᵢⱼ) is the sum of:
   the input vector corresponding to the row of the input data matrix, said row corresponding to the row position of the addition vector (i.e., in position X*row, Y*column of matrix X̅*_{N×K}, the vector of the corresponding X* row from matrix A*); and
   the output vector corresponding to the column of the output data matrix, said column corresponding to the column position of the output vector (i.e., in position X*row, Y*column of matrix X̅*_{N×K}, the vector of the corresponding Y* column from matrix B);

Furthermore, when matrix X̅*_{N×K} is generated, within each addition vector \vec{x}*ᵢⱼ, a maximum or minimum value within the same vector may be selected, to generate the resulting matrix of weights matrix X̅_{N×K}, which may comprise the maximum or minimum value of each addition vector \vec{x}*ᵢⱼ, in the same position where addition vector \vec{x}*ᵢⱼ was.

This selection and generation may be performed by steps i) and j):
c) Selecting, for each addition vector, a maximum or minimum value among the elements of the addition vector;
d) Generating a matrix of weights for the neural network, wherein each weight of the matrix is the selected maximum or minimum value of the vector found in the same position of the matrix of addition vectors as the position of the weight within the matrix of weights.

The selection of the maximum or minimum may depend on which solution of the max-plus semiring may be used to solve the max-plus system of linear equations. However, the choice of maximum or minimum in said selection may also determine the inference performed when using the trained neural network after the training has been performed (i.e. when the matrix of weights has already been generated).

More specifically, the contrary may be used in the inference process: that is, if the selection of the greater values (i.e. the maximum) is performed in step i) during the training process, a subsequent inference may involve calculating the minimum value to solve the inference linear equations. And vice versa: if the selection of the minimum values is performed is step i), a subsequent inference using the trained neural network may involve calculating the maximum value to solve the inference linear equations.

According to an example of the present disclosure, the step of selecting, for each addition vector, a maximum or minimum value may comprise selecting for all the addition vectors the respective maximum value.

That is, when the selection may be performed, only the maximum within each addition vector may be selected, thus selecting the same number of values as the number of addition vectors. Therefore, each selected maximum value may be a local maximum within the elements of the corresponding addition vector.

Alternatively, the step of selecting, for each addition vector, a maximum or minimum value may comprise selecting for all the addition vectors the respective minimum value. In an analogous way, the local minimums within the elements of the corresponding addition vector may also be selected, since, as previously described, both alternatives, found within the max-plus semiring, may be used to generate the matrix of weights of the neural network.

Furthermore, a combination of selections of maximums and minimums may also be performed, wherein a first group of addition vectors may be used to perform a selection of the maximum, and the rest of the addition vectors may be used to perform the selection of the minimum. When performing such alternative, it may have to be taken into account when using the resulting weights corresponding to each group of addition vectors. More precisely, the weights resulting from the group wherein a selection of a maximum is performed, may have to be used within the inference of the neural network, by applying a selection of the minimum of the sums performed between the weights and new input data (used to infer the output of the neural network). Equally, the weights resulting from the group wherein a selection of a minimum is performed, may have to be used within the inference of the neural network, by applying a selection of the maximum of said sums. All of this may be possible because of the previously described characteristic of the max-plus semiring.

According to an example of the present disclosure, the electronic system may further comprise an adder digital circuit and a comparison digital circuit, wherein:
the input data matrix comprises L rows and N columns, the input data matrix corresponding to a single input training data set of samples used to train the neural network;
the output data matrix comprises L rows and K columns, the output data matrix corresponding to a desired output training data set used to train the neural network, the desired output training data set being paired with the single input training data set;

wherein the elements of the input data matrix and the desired output data matrix; numbers L, N and K are natural numbers, N being the number of neurons to be trained of the neural network, K being the number of possible outputs to be trained of the neural network, and L being the number of samples used to train the neural network; and wherein the steps a) to e) may further comprise the following steps:
for each neuron j of the neural network, wherein j is a natural number, and 1=<j=<N:
   a for each output k of the neural network, wherein k is a natural number and is 1=<k=<K, performing the steps of:
      negating the elements of column j of the input data matrix;
      generating an addition vector by performing a matrix addition of column k of the desired output data matrix with the previously negated column j of the input data matrix, the matrix addition being performed by the adder digital circuit;
      generating a weight x̅ⱼₖ, by selecting an element among all the elements of the previously obtained addition vector, the selected element being either the maximum or the minimum value among all values of each element of the addition vector, the selection being performed by the comparison digital circuit;
   generating a weight vector \vec{\vec{x}}j comprising all the generated weights x̅ⱼₖ for the neuron j;
      and wherein step f) further comprises:
generating a weight data matrix comprising, for each row corresponding to each neuron j, the corresponding weight vector \overline{\vec{x}}ⱼ, wherein the weight data matrix has N rows and K columns.

According to this example, in a generic way:
input data matrix, generically named matrix A, may be a two-dimensional matrix of L rows and N columns;
weight data matrix, generically named matrix X̅, may be a two-dimensional matrix of weights which, after the training process, may be of N rows and K columns; and
output data matrix, generically named matrix B, may be a two-dimensional matrix of L rows and K columns;

And wherein each element of each data matrix comprises data encoded in binary code.

Furthermore, parameter N refers to the number of neurons used in the training of the neural network (or neurons which are about to be trained), K may be the number of possible outputs to be trained of the neural network, for example, the number of categories to be recognized or the number of signals to be predicted (depending on how the neural network is being used). Finally, L relates to the set of measures or samples used to perform the training. More specifically, L is the number of states (or outputs) of the neural network's neurons taken into account in the training process. For example, L may be the number of samples inputted to the neural network when training the neural network.

Firstly, the example of the present method may be performed in a first loop for each neuron j of the neural network, wherein j is a natural number, and 1=<j=<N (that is, the resulting weight matrix X̅ comprises N rows, wherein each row corresponds to a neuron of the neural network, which may end up trained when the method is performed).

Secondly, inside the first loop, a second loop may also be performed for each output k of the neural network, wherein k is a natural number and is 1=<k=<K (that is, the resulting weight matrix X comprises K columns, wherein each column corresponds to the mapping of an input with a possible output of the neural network, the mapping being generated when the method is performed, i.e., the neural network is trained).

Inside both nested loops, each column j of the input data matrix may be negated, and, by the following steps, the input data matrix is further transposed (by selecting columns of the input data matrix instead of rows), and the corresponding vectors are summed (by operating the columns of the input data matrix, i.e., the input vectors, with the columns of the output data matrix, i.e., the output vectors), generating the corresponding addition vectors, by performing the step of:
generating an addition vector by performing a matrix addition of column k of the desired output data matrix with the previously negated column j of the input data matrix, the matrix addition being performed by the adder digital circuit;

More precisely, element by element, the sums of each column of the negated and transposed input data matrix with the k^{th} column of the output data matrix, may be performed. This sum may be a matrix addition of column k of the output data matrix with the previously negated column j of the input data matrix. Such sum may be performed by electrically coupling each corresponding element of both matrixes, for each individual sum, into the inputs of an adder digital circuit, which may be, for example, a part of the integrated circuit which comprises an array of digital adders with the corresponding number of inputs. Each output of the adder digital circuit may deliver a binary signal corresponding to the result of each sum.

Furthermore, nested within the same two loops, the weights may be generated by applying the selection of the maximum or minimum value within each resulting addition vector, as previously described. More specifically, according to this example, the selection may be performed by a comparison digital circuit within the electronic system, the comparison digital circuit performing the step of:
generating a weight \vec{x}ⱼₖ by selecting an element among all the elements of the previously obtained addition vector, the selected element being either the maximum or the minimum value among all values of each element of the addition vector, the selection being performed by the comparison digital circuit;

The implementation of the search of the maximum or minimum value of the elements within each addition vector, i.e., the values found in each coordinate of the corresponding addition vector, may be performed by inputting the elements of the addition vector into a comparison digital circuit.

More specifically, the selection may be performed by a comparison digital circuit, which may be a circuit which compares two or more signals digitally encoded in binary code, therefore being a digital circuit. However, the comparison digital circuit may internally perform the comparison using characteristics of analog signals (an example of such circuit may be the one described in the paper with reference: D. Miyashita et al., “An LDPC Decoder With Time-Domain Analog and Digital Mixed-Signal Processing,” in IEEE Journal of Solid-State Circuits, vol. 49, no. 1, pp. 73-83, January 2014, doi: 10.1109/JSSC.2013.2284363), or with a circuit comprising logic gates to perform the comparison in a parallel way (more specifically, for example, circuits comprising at least one AND logic gate, or at least one OR logic gate, depending on how the data of the addition vector is encoded, which perform the operations in parallel).

However, when implemented in hardware, all the previously mentioned alternatives of comparison circuits may result in a balance between amount of hardware and operation time of the operation (which, according to this disclosure, may be related to, at least, the comparison which the comparison circuit may perform). Furthermore, the operation time may be increased as the accuracy increases. Other previously known solutions for selecting the maximum or minimum value among all values of each element of the addition vector would require, for example, a comparison operation which may be a parallel operation (requiring a larger amount of hardware, i.e., look-up tables or logic gates, but lower time, i.e., operating clock cycles). Alternatively, it may also require a sequential-type operation (requiring less hardware, i.e., look-up tables or logic gates, but a much larger amount of time, i.e., operating clock cycles). For example, a sequential operation to perform the comparison may be implemented using conventional digital comparators of numbers encoded in binary code. However, the alternatives of the present disclosure result in a compromise between the amount of time needed (which may be higher than a parallel operation, but not substantially higher in terms of standard operation time of the neural network) and the amount of hardware, which may be enormously reduced (compared to the amount of hardware needed when performing a parallel operation, while not reaching the small amount of hardware needed in a sequential operation).

Subsequently, at the output of the comparison digital circuit, a minimum or maximum value among the set of sums may be selected, for every addition vector. If the minimum is calculated, it may be taken into account in the inference process of the neural network, wherein a maximum may be selected. In an analogous way, if the maximum is calculated, in the inference process, a minimum may be selected. This way, an estimate of each weight, which may be j^{th} element of the k^{th} column of the weight matrix X, may be obtained.

This process may be repeated for all the elements of matrix X in order to calculate all the weights of the neurons being trained, of the neural network. However, the neural network may comprise more neurons with other untrained weights, thus it is possible to partially train a neural network. Such repetition is performed by the following step, nested in the first loop of the method:
generating a weight vector \overline{\vec{x}}ⱼ comprising all the generated weights x̅ⱼₖ for the neuron j;

Wherein all the vectors \overline{\vec{x}}ⱼ are generated for each of the columns (i.e., each of the neurons which are being trained) of the matrix of weights, thus generating the matrix X̅ of weights. Once the matrix X̅ of weights is generated, it may be ready to be operated with a different neural network activity at any time for the network to estimate, for example, the prediction, classification, etc. . . . . Therefore, a new input data matrix A₀ may be used, which may be different from the activity used in the training process (generically named matrix A), corresponding to the network stimuli changing with new inputted samples.

The use of the linear regression operation as described in the above example allows implementing a digital system in an electronic system, capable of performing a supervised training of a neural network in a non-iterative way, by dramatically reducing the cost of the digital circuits within the electronic system. Furthermore, a substantial saving of integrated circuit area and power consumption may also be achieved. Furthermore, by using the electronic system of the present disclosure, it is possible to avoid the transfer of big amounts of data used in the training or inference through, for example, an unsafe network. This may be particularly useful in edge computing. More specifically, big data transfers may be avoided from the devices at the edge to the cloud servers, thus reducing the pressure on the communication medium pointing from the devices at the edge to the cloud servers. This may also enhance the privacy of users, because this way, the raw data never leaves the device where the training or inference is performed. Furthermore, in some cases, neural networks implemented within an electronic system, such as, for example, an integrated chip apparatus, may be trained off-chip (i.e., the weights of the network may be obtained outside the chip, for example in a computer server), and then uploaded into the neural network, in the chip. In these cases, large amounts of data may also be sent through unsafe networks. By using the electronic system of the present disclosure, such transfers of data between the electronic system and a server may also be avoided.

Such circuitry may be implemented, for example, in a plurality of specific-purpose integrated circuits (known as ASICs), programmable logic circuits (known as FPGAs), or programmable electronic device such as a CPLD (Complex Programmable Logic Device), all of them being digital circuits capable of performing linear adjustments non-iteratively and entirely in hardware, without any external computational aid (for example, connecting to a server, or performing parts of the training in the form of software in an external computer or server).

Moreover, the training may be fully embedded in an electronic system, which may not require a constant connection to a communications network, such as, for example, Wi-Fi connection to Internet, or at least when performing the training of the neural network. Furthermore, connections to a cloud, which are very usual in data management of neural networks, are further avoided when performing the training, and the resulting weight data matrix may have a size which can be stored in a further electronic system, such as, for example, an integrated chip (or within the same electronic system performing the training) due to its size reduction.

Therefore, such digital circuit may be useful, for example, for those systems in which integration of an on-chip linear adjustment system with low cost in terms of logic gates and energy consumption is required. Examples of such systems may be those involving time series processing (for example, prediction) or pattern recognition (for example, image recognition), which may be easily implemented in, for example, portable devices such as smartphones, integrated circuits of devices not connected to the Internet, or any other IoT device that may function independently, reporting only the results of the training or inference of the neural network to another device or computing system.

The electronic system according to the present disclosure may be used within different hardware systems, such as, for example, a system to create images from audio signals which may me used as a training database for a neural network, e.g., a convolutional network. Subsequently the same circuitry may process new audio signals so that the already trained neural network may be able to classify the new audio signal into one of the learned categories. Then, the resulting images may comprise the weights of the trained neural network, to be used for different purposes. For example, the resulting image (comprising the weights of the trained neural network) may be used to predict future values of the audio signal itself.

Another use of the present electronic system may be within a system to predict the future state of a time series. For example, in the case of a robot which makes estimates of the future state of a variable, and further prepares to respond based on its evolution. A clear example is the case of a robot playing soccer. It has to make estimates of the trajectory of the ball to decide when to move a limb to hit the ball. Each of the vector components of the trajectory may be considered as a time series to be predicted.

The electronic system may also be used, for example, to train a neural network to recognize images, in a standard way known in the state of the art, the resulting training circuitry being more efficient than other training methods.

According to an example of the present disclosure, the generated addition vector may be embedded in a digital signal comprising a data vector resulting from a Digital temporal encoding. More specifically, temporal encoding may be defined as a type of encoding wherein information is represented and processed in the form of delayed transitions in 1-bit signals. According to the present disclosure, each resulting output of each sum performed for each combination of the matrix addition (i.e., each coordinate of the resulting addition vector) may be an element represented by a single bit, which may evolve over time, and said time evolution may represent a binary number (therefore, being a digital temporal encoding of each coordinate of the addition vector). Said signal of 1 bit may be electrically coupled to the input of the comparison digital circuit. Therefore, in this example, the input of the comparison digital circuit may comprise a bus of L lines, wherein each line is electrically coupled to a line of the bus and carries a 1-bit signal encoded in a temporal way.

According to an example of the present disclosure, when the generated addition vector may be embedded in a signal temporally encoded, the comparison digital circuit may comprise:
One or more OR logic gates, in case the step of selecting, for each addition vector, a maximum or minimum value comprises selecting for the respective minimum value using all or a group of temporally encoded addition vectors. Therefore, when temporally encoding a group of addition vectors and selecting a local minimum within each of them, at least one OR logic gate may be used to perform such selection.
One or more AND logic gates, in case the step of selecting, for each addition vector, a maximum or minimum value comprises selecting for the respective maximum value using all or a group of temporally encoded addition vectors. Therefore, when temporally encoding a group of addition vectors and selecting a local maximum within each of them, at least one AND logic gate may be used to perform such selection.

These alternatives are all possible due to characteristics of the temporally encoded signals, which allow performing such selections of maximums or minimums with the previously described logic gates.

Alternatively, according to another example of the present disclosure, the generated addition vector may be embedded in a digital signal comprising a data vector resulting from a Digital stochastic encoding, used within what is known as digital stochastic computing. More specifically, stochastic encoding may be defined as a type of encoding wherein information is represented and processed in the form of digitized probabilities. Stochastic computing (SC) was proposed in the 1960s as a low-cost alternative to the architecture of Von Neumann. However, because of its intrinsically random nature, a resulting lower accuracy discouraged its use in digital computing. However, when used within the hardware implementation of the training process of a neural network, it may be useful to substantially reduce the amount of hardware needed to perform the training. This dramatic decrease in hardware comes with a decrease of accuracy and computing time, which is acceptable for the majority of applications of such neural networks as pattern recognition networks, wherein the output of the neural networks are classes that may not need a very high accuracy.

In an analogous way, according to another example of the present disclosure, when the generated addition vector may be embedded in a signal stochastically encoded, the comparison digital circuit may comprise:
One or more AND logic gates, in case the step of selecting, for each addition vector, a maximum or minimum value comprises selecting for the respective minimum value using all or a group of stochastically encoded addition vectors. Therefore, when stochastically encoding a group of addition vectors and selecting a local minimum within each of them, at least one AND logic gate may be used to perform such selection.
One or more OR logic gates, in case the step of selecting, for each addition vector, a maximum or minimum value comprises selecting for the respective maximum value using all or a group of stochastically encoded addition vectors. Therefore, when stochastically encoding a group of addition vectors and selecting a local maximum within each of them, at least one OR logic gate may be used to perform such selection.

These alternatives are all possible due to characteristics of the stochastically encoded signals, which allow performing such selections of maximums or minimums with the previously described logic gates.

According to another aspect of the present disclosure, an electronic system for non-iterative training of a neural network is presented, the training based on training data including an input data matrix and an output data matrix, the output data matrix being expected for said input data matrix, wherein the output data matrix comprises a plurality of output vectors corresponding to each column of the output data matrix, the training resulting in a matrix of weights of the neural network, and wherein the system comprises:
A transposing module configured to transpose the input data matrix;
A negating module configured to negate the elements within the transposed input data matrix;
A first selecting module configured to select a plurality of input vectors corresponding to each row of the transposed and negated input data matrix;
A matrix generation module configured to generate a matrix of addition vectors, wherein each addition vector is the sum of:
   the input vector corresponding to the row of the input data matrix, said row corresponding to the row position of the addition vector; and
   the output vector corresponding to the column of the output data matrix, said column corresponding to the column position of the output vector;
A second selecting module configured to select, for each addition vector, a maximum or minimum value among the elements of the addition vector;
An output module configured to generate a matrix of weights for the neural network, wherein each weight of the matrix is the selected maximum or minimum value of the vector found in the same position of the matrix of addition vectors as the position of the weight within the matrix of weights.

The electronic system according to the present disclosure may be embedded in a plurality of hardware devices, such as, for example, a programmable electronic device such as a CPLD (Complex Programmable Logic Device), an FPGA (Field Programmable Gate Array) or an ASIC (Application-Specific Integrated Circuit), or a combination thereof.

Furthermore, according to a specific example, the electronic system may be embedded in a single electronic system, such as, for example, a single integrated circuit chip apparatus. This way, a gain in power consumption and computing time may be achieved when performing the non-iterative training of a neural network. Also, the modules of the electronics may occupy less physical space, thus rendering the chip apparatus suitable to be installed within a small consumer electronics device, such as, for example, a smartphone or a tablet. Furthermore, when installed within such devices, a low power consumption may be achieved by the consumer device, comparing it to the traditional processes used to train a neural network within or by such devices.

According to an example of the present disclosure, the matrix generation module may comprise an array of binary digital adders to perform the sum of the addition vectors.

According to another example, the system may further comprise at least one stochastic encoder to encode at least one addition vector. More precisely, at the output of each sum performed within the matrix generation module (for example, at the output of each sum performed by an array of binary digital adders found within said module), a stochastic encoder may be connected, which encodes each line carrying the result of each sum in binary, into a stochastic signal. Such encoding may be performed over different periods of time, thus decreasing the stochastic noise as such periods of time increase, thus making the encoding more precise.

According to another example, the selection of local maximums or minimums, and the generation of the matrix of weights may be performed using stochastically encoded signals, thus delivering the weights within the matrix of weights as stochastically encoded signals. This may be useful if the matrix of weights is outputted by the electronics system as a bus which is directly connected to an inference module to perform the inference of the trained neural network. Therefore, if there is no decoding of the weights back to binary, and stochastic encoding again to perform the inference, the computing time of the training and the inference, in combination, may be shorter, thus making the electronics system of the present disclosure faster when combined with an inference module.

According to another example, the system may further comprise at least one temporal encoder to encode at least one addition vector. More precisely, at the output of each sum performed within the matrix generation module (for example, at the output of each sum performed by an array of binary digital adders found within said module), a temporal encoder may be connected, which encodes each line carrying the result of each sum in binary, into a temporal signal. Such encoding may be performed in several known ways, such as using DTCs comprising, for example, binary counters.

Alternatively, from among all the generated addition vectors, a plurality of them may be stochastically encoded, and the rest may be temporally encoded. In such case, each line may have to be decoded accordingly, and the selection of maximums or minimums may have to take into account the use of such encoding of the generated addition vectors.

According to an example, the second selection module may comprise a comparison digital circuit, which may comprise:
An OR logic gate, if the addition vectors to be compared are temporally encoded, and a minimum is selected; or
An AND logic gate, if the addition vectors to be compared are stochastically encoded, and a minimum is selected.

Such OR logic gate or AND logic gate may have, as an input, the corresponding generated addition vectors, and may output the minimum among all the inputs, which may still be encoded correspondingly.

Furthermore, in an analogous way, an alternative example may be such that the comparison digital circuit may comprise:
An AND logic gate, if the addition vectors to be compared are temporally encoded, and a maximum is selected; or
An OR logic gate, if the addition vectors to be compared are stochastically encoded, and a maximum is selected.

As previously described, such options may be possible due to the characteristics of either digital temporal encoding or stochastic computing.

According to an example of the present disclosure, the input data matrix may comprise data related to a sound signal, for example, obtained from a microphone, a sound file or other sound related data. Furthermore, the generated matrix of weights may describe features of the sound signal, and the matrix of weights may be used to generate a prediction of the sound signal over time. More precisely, a neural network may be trained by the system for non-iterative training according to the present disclosure, by inputting a data matrix comprising data from, for example, a microphone, a sound file or other sound related data. The resulting weights of such training may be interpreted to describe features of the sound signal (the sound signal being represented by the input data matrix used to train the network) and may also be used to generate a prediction of the sound signal over time.

Furthermore, the obtained weights may also be used as input data to train a second neural network to be a sound classification system. Once said second network is trained, the obtained weights may further be used as input data for the second neural network to further recognize the class which a sound signal corresponds to. For example, by observing the output of the second neural network, a classification of a sound signal may be obtained to be used, for example, for speech recognition or Audio Event Recognition (AER).

According to an example of the present disclosure, the electronic system for non-iterative training of a neural network may further comprise an inference module configured to infer the trained neural network, the inference being based on inference data including an inference input data matrix and the generated matrix of weights, the inference module comprising:
A first selecting module configured to select a plurality of inference input vectors corresponding to each row of the inference input data matrix;
A second selecting module configured to select a plurality of inference vectors corresponding to each column of the matrix of weights;
A matrix generation module configured to generate a matrix of inference addition vectors, wherein each inference addition vector is the sum of:
   the inference input vector corresponding to the row of the inference input data matrix, said row corresponding to the row position of the inference addition vector; and
   the inference vector corresponding to the column of the matrix of weights, said column corresponding to the column position of the inference addition vector;
A third selecting module configured to select, for each inference addition vector, a maximum or minimum value among the elements of the inference addition vector;
An output module configured to generate a matrix of inferred outputs for the neural network, wherein each elements of the matrix is the selected maximum or minimum value of the inference vector found in the same position of the matrix of inference addition vectors as the position of the inferred output within the matrix of inferred output.

The inference module may be integrated in a single chip embedded with the electronic system for training the neural network, therefore saving hardware space and operation time, by connecting the generated matrix of weights directly into the matrix generation module of the inference module. Alternatively, it may be a separate system that is connected to the output of the electronic system used for the training of the neural network. In such case, the matrix of weights may also be connected to the matrix generation module of the inference module, or the weights may be stored in a buffer or memory, and the inference module may retrieve the generated matrix of weights from such buffer/module, in order to use it for the inference performed within.

These alternatives allow flexibility when designing the hardware (for example, embedding the training and the inference within a single chip apparatus, or performing the inference externally in another device).

According to another example, the third selecting module may select, for each inference addition vector:
a maximum, if the weights of the inference vector have been generated by selecting a minimum value within the corresponding addition vector, by the second selecting module of the electronic system for non-iterative training of a neural network; and
a minimum, if the weights of the inference vector have been generated by selecting a maximum value within the corresponding addition vector, by the second selecting module of the electronic system for non-iterative training of a neural network.

According to an example, the third selecting module of the inference module may comprise a comparison digital circuit to perform the selection of a maximum or a minimum, and wherein the comparison digital circuit may comprise:
An OR logic gate, if the third selecting module selects a maximum and the inference addition vector is stochastically encoded; or
An AND logic gate, if the third selecting module selects a maximum and the inference addition vector is temporally encoded.

Furthermore, in an analogous way, an alternative example may be such that the comparison digital circuit may comprise:
An OR logic gate, if the third selecting module selects a minimum and the inference addition vector is temporally encoded; or
An AND logic gate, if the third selecting module selects a minimum and the inference addition vector is stochastically encoded.

As previously described, such options may be possible due to the characteristics of either digital temporal encoding or stochastic computing.

### BRIEF DESCRIPTION OF THE DRAWINGS

Non-limiting examples of the present disclosure will be described in the following, with reference to the appended drawings, in which:

FIG. 1 depicts an example of a schematic representation of the generic structure of a neural network, such as a Reservoir Computing (RC) or an Extreme Learning Machine (ELM).

FIG. 2 depicts an example of a first embodiment of the integrated circuit chip apparatus according to the present disclosure.

FIG. 3 depicts an example of a second embodiment of the integrated circuit chip apparatus according to the present disclosure.

FIG. 4 depicts an example of the inference of a neural network, according to the present disclosure.

FIG. 5 depicts another example of the inference of a neural network, according to the present disclosure.

FIG. 6 depicts a temporal diagram of signals used within an example of a DTC circuit arrangement using temporal signals, according to the present disclosure;

FIG. 7 depicts an example of a DTC circuit arrangement for selecting a minimum from two temporally encoded signals, according to the present disclosure.

FIG. 8 depicts an example of a DTC circuit arrangement for the sum of two binary values by means of DTC components according to the present disclosure.

FIG. 9 shows a temporal diagram of signals used within an example of a DTC circuit arrangement for temporally encoding a binary signal, according to the present disclosure.

### DETAILED DESCRIPTION OF EXAMPLES

The examples of the present disclosure depict different designs of an electronic system embedded in a single integrated circuit chip apparatus, comprising a plurality of digital circuits implemented using temporal and stochastic computing, combined with traditional binary logic, to train a neural network in a non iterative way, resulting in a weight data matrix of a neural network. The present disclosure can be used within different types of devices or systems, wherein a non-iterative AI training may be required, such as in the case of some Neural Networks (NNs), especially, Extreme Learning Machines (ELMs) or Reservoir Computing (RC) systems.

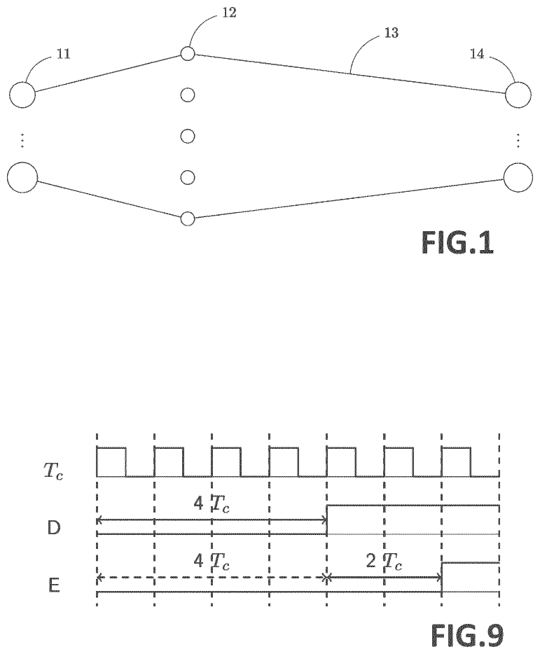

More specifically, FIG. 1 shows a schematic representation of the generic structure of a neural network such as an ELMs or a RC network, as mentioned above. These neural networks generally comprise, as depicted in FIG. 1:
an input layer 11 (i.e., where the samples used to train the neural network are inputted);
a hidden layer or reservoir layer 12, comprising a plurality of neurons, and whose activity (output) results in the input matrix A;
the linear operation 13 performed between the outputs of the hidden layer 12 and the weights of the output of the neural network (i.e., the operation of A and X); and
an output layer 14 of the activity of said network (also known as the output of the neural network, resulting from the operation of matrices A and X, i.e., output matrix \hat{B}, which denotes the estimation made by the neural network of the reference output matrix B).

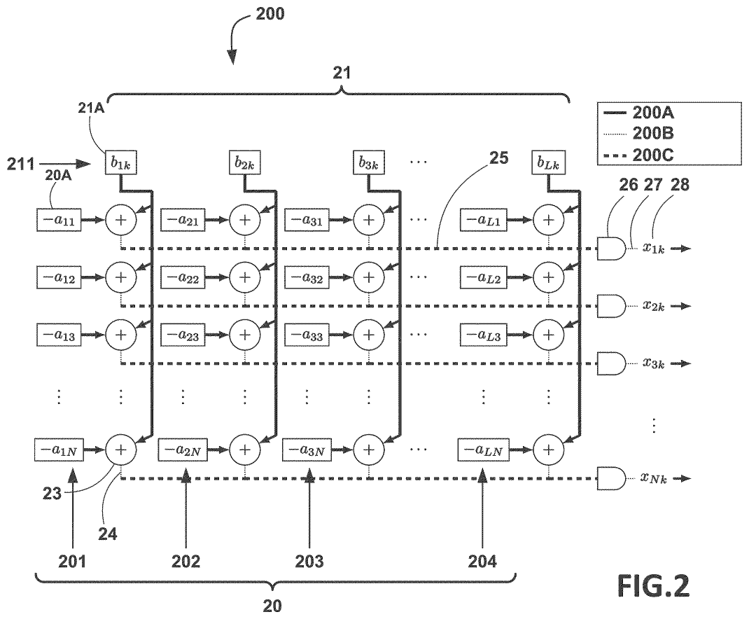

FIG. 2 depicts an example of a first embodiment of the integrated circuit chip apparatus according to the present disclosure. More specifically, it depicts a circuit diagram based on the use of digital circuits operating with signals encoded in both traditional binary logic and stochastic logic. In this example, the apparatus 200 comprises a first input bus 20 and a second input bus 21, wherein the first input bus 20 is configured to input an input data matrix A with L rows and N columns, comprising generic elements aᵢⱼ 20A of, in this case, n bits each element. Furthermore, the second input bus 21 is configured to input an output data matrix B with L rows and K columns, comprising generic elements bᵢⱼ 21A of, in this case, n bits each element. Moreover, in FIG. 2, discontinuous thick lines 2000 depict stochastically encoded buses (carrying stochastically encoded signals, and the bus is L-bits wide), dotted lines 200B depict stochastically encoded one bit buses (carrying stochastically encoded signals, and the bus carrying one bit only), and continuous thick lines 200A depict traditional binary encoded buses (carrying binary encoded signals of n bits, in case no overflow in the operations occurs, in which case n would be increased by one or more bits, as needed because of the overflow).

As it can be seen, the elements of each matrix A and B are arranged within the corresponding input bus of the integrated chip apparatus in such a way that the linear regression operation of the present disclosure is defined, by, firstly, generating a plurality of addition vectors by performing a matrix addition of each element of the k^{th} column 211 of the output data matrix B (inputted in the second input bus 21), with the corresponding element of the previously negated column j of the input data matrix A (columns 201, 202, 203 and up to column 204, which correspond to each negated column of input data matrix A, from column 1 to column L). More specifically, the bᵢₖ element of 211 with all the elements of the j^{th} column of negated matrix A. Such arranging of such matrix addition is defined by the following expression:

\vec{x}*ᵢⱼ=(−a₁ᵢ+b₁ⱼ,−a₂ᵢ+b₂ⱼ, . . . ,−a_{Li}+b_{Lj})

The matrix addition may be performed, in this example, by an adder digital circuit, more precisely, an array of binary digital adders 23. All the lines 200A corresponding to the first input bus 20 and the second input bus 21 which flow into each part of the array of binary digital adders may be encoded in binary code.

In this particular example, a stochastic encoder is coupled to each output of each sum of the array of binary digital adders 23, thus encoding the output signal of each sum of the array 23 into a stochastic signal. Therefore, the output of each sum is a single bit bus 24 which, combined with the corresponding outputs of the L sums of the same row in the figure, as depicted (and following the linear regression operation formula previously described) forms a bus 25 of L bits, each line of the bus encoded as stochastic signals, and each bus 25 forming each generated addition vector, stochastically encoded.

Stochastic computing uses single bit pulsed signals to represent quantities. The quantity represented will be related to the probability of those bits being set to ‘1’. Stochastic computing may employ low complexity computational circuits to perform sums, subtractions, multiplications and other operations between signals. For example, in order to perform a selection of a minimum value among two or more correlated stochastic signals, an AND logic gate may be used. However, its intrinsically random nature may involve a lower accuracy for those operations when compared to other computing methods (such as, for example, Von Neumann architecture). Therefore, they have rarely been used in the past in computing implementations which require a high accuracy.

Therefore, in this embodiment, in order to select a minimum value of the elements within each addition vector, i.e., the values found in each coordinate of the corresponding addition vector (found in buses 25), each addition vector may be inputted into a comparison digital circuit, which may be an AND gate (according to the previously described features of stochastic computing).

In this particular case, each coordinate of each addition vector (found in buses 25) is a single bit digital signal carrying a stochastically encoded number (the result of each previously performed sum). Therefore, a selection may be performed by inputting all the stochastically encoded bits (L bits) into the corresponding AND gate 26, thus selecting, in the output of the AND gate 26, a local minimum stochastically encoded among the L different stochastically encoded single bit signals of the corresponding bus 25.

By encoding the results of each sum into stochastic signals and using an AND gate to select the minimum of each addition vector, a massive implementation of hardware neurons may be achieved. Therefore, the outputs of each AND gate 26 may output, in a single bit signal 27, the corresponding weight x̅ᵢₖ for each corresponding addition vector i. Therefore, a weight vector may be generated (comprising all the weights of x̅ᵢₖ), for each k^{th} column of matrix B, in turn, generating a weight matrix X̅ (comprising all the K generated weight vectors). In this embodiment, each weight may be generated as a stochastic signal, and may be converted back into a binary encoded signal, by coupling a stochastic decoder to the output 27 of each AND gate 26, thus outputting each weight 28 as a binary encoded signal.

As previously described, the use of stochastically encoded signals to perform the linear regression operation of the present disclosure, in general computing terms, may not have a high accuracy. Nevertheless, the use of stochastic computing to generate and select local maximums within the addition vectors (instead of other standard traditional binary operations, such as performing binary operations in parallel) allows reducing the amount of hardware used to perform the linear regression operations of the present training method.

The loss in accuracy (which relates to the time used to code and decode stochastic signal), may be negligible when such technique is used within the non-iterative training process of a neural network. For example, when such a training method is used in a pattern recognition system, said loss of accuracy of the output of the neural network (after the training) may not substantially affect to the performance of the pattern recognition.

Furthermore, the efficiency of the hardware to perform such training may be improved, by requiring a low power consumption. Such efficiency may be relevant in implementations wherein the chip apparatus is embedded in, or connected to hardware resources of, for example, a consumer electronics device (for example, a smartphone).

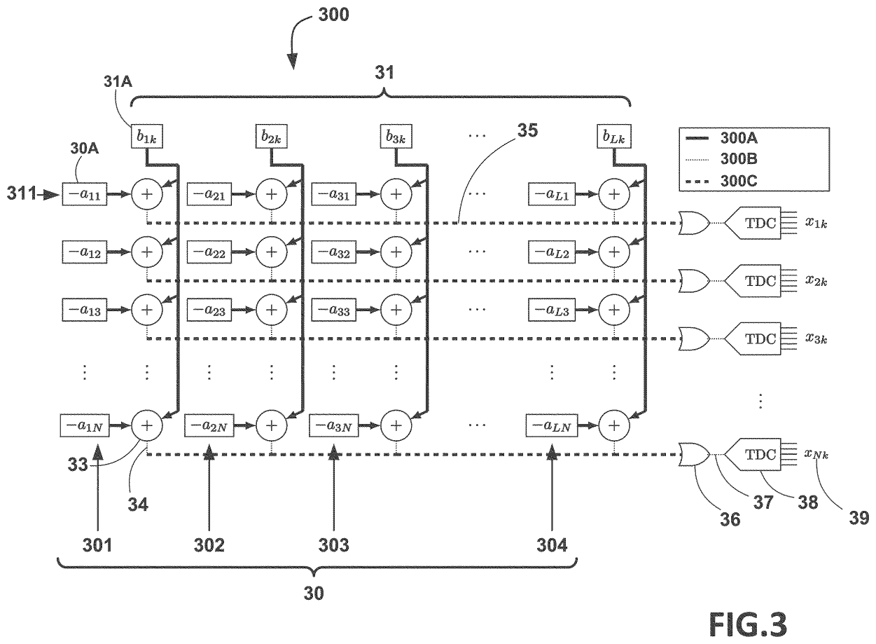

FIG. 3 depicts an example of a second embodiment of the integrated circuit chip apparatus according to the present disclosure. More specifically, it depicts a circuit diagram based on the use of digital circuits operating with signals encoded in both traditional binary logic and temporal encoding. In this example, the apparatus 300 comprises a first input bus 30 and a second input bus 31, wherein the first input bus 30 is configured to input an input data matrix A with L rows and N columns, comprising generic elements aᵢⱼ 30A of, in this case, n bits each element. Furthermore, the second input bus 31 is configured to input an output data matrix B with L rows and K columns, comprising generic elements bᵢⱼ 31A of, in this case, n bits each element. Moreover, in FIG. 3, discontinuous thick lines 3000 depict temporally encoded buses (carrying temporally encoded signals, and the bus carrying L bits), dotted lines 300B depict temporally encoded one bit buses (carrying temporally encoded signals, and the bus carrying one bit only), and continuous thick lines 300A depict traditional binary encoded buses (carrying binary encoded signals of n bits, in case no overflow in the operations occurs, in which case n would be increased by one or more bits, as needed because of the overflow).

As it can be seen, the elements of each matrix A and B are arranged within the corresponding input bus of the integrated chip apparatus in such a way that the linear regression operation of the present disclosure is defined, by, firstly, generating a plurality of addition vectors by performing a matrix addition of each element of the k^{th} column 311 of the output data matrix B (inputted in the second input bus 31), with the corresponding element of the previously negated column j of the input data matrix A (columns 301, 302, 303 and up to column 304, which correspond to each negated column of input data matrix A, from column 1 to column L). More specifically, the bᵢₖ element of 311 with all the elements of the j^{th} column of negated matrix A. Such arranging of such matrix addition is defined by the following expression:

\vec{x}*ᵢⱼ=(−a₁ᵢ+b₁ⱼ,−a₂ᵢ+b₂ⱼ, . . . ,−a_{Li}+b_{Lj})

The matrix addition may be performed, in this example, by an adder digital circuit, more precisely, an array of binary digital adders 33. All the lines corresponding to the first input bus 30 and the second input bus 31 which flow into each part of the array of binary digital adders may be encoded in binary code.

In this particular example, a Digital Temporal Encoder (DTC) is coupled to each output of each sum of the array of binary digital adders 33, thus encoding the output signal of each sum of the array 33 into a temporal signal. Therefore, the output of each sum is a single bit bus 34 which, combined with the corresponding outputs of the sums of the same row in the figure, as depicted (and following the linear regression operation formula previously described) forms a bus 35 of L bits, wherein each line of the bus is encoded as a temporal signal, and each bus 35 forming each generated addition vector, temporally encoded.

The temporal encoding may be analogous to the stochastic encoding. More precisely, the binary encoded signals (outputted by the binary digital adders 33) may be encoded into 1-bit digital signals by means of a Digital Temporal Coder (DTC) at the output of each binary adder 33. Therefore, the binary signals of n bits may be encoded as 1-bit signals, operated, and further decoded back to n-bit signals, thus converting those signals back to their corresponding binary quantities. Said decoding may be performed by means of a Temporal Digital Converter (TDC).

In the examples in all figures, DTCs and TDCs are depicted to have an input bus with a plurality of input cables which are only exemplary and may not be the exact same quantity depending on the case. More precisely, all the DTC and TDC depictions have 5 input cable, but, depending on the number inputted, they may not have said number of input bits.

More specifically, the DTC may be implemented by a counter that counts from 0 to 2P-1, wherein P may be the number of bits used to code the binary number to be coded into a 1-bit digital temporal signal. The number to be coded is compared with the counter output at each clock cycle. If the binary number to be coded is greater than the output of the counter, then the DTC output may be a 0. Otherwise, the DTC output may be 1. The DTC output may work with a set starting time and during a fixed period of time.

By encoding the results of each sum into temporal signals and using an OR gate to select the minimum of each addition vector, a massive implementation of hardware neurons may be achieved. Therefore, the outputs of each OR gate 36 may output, in a single bit signal 37, the corresponding weight x̅ᵢₖ for each corresponding addition vector i. Therefore, a weight vector may be generated (comprising all the weights of x̅ᵢₖ), for each k^{th} column of matrix B, in turn, generating a weight matrix X̅ (comprising all the K generated weight vectors). In this embodiment, each weight may be generated as a temporal signal, and may be converted back into a binary encoded signal, by coupling a TDC 38 decoder to the output 37 of each OR gate 36, thus outputting each weight 39 as a binary encoded signal.

FIG. 7 shows an example of a circuit arrangement to perform a selection of a minimum using digital temporal encoding. More specifically, FIG. 7 depicts an example of the selection of a minimum between two binary quantities 71, wherein both binary signals may be converted to the corresponding temporal signal A and B in buses 73, by using the corresponding DTC devices 72. The resulting temporally encoded 1-bit signals A and B may be inputted in an OR logic gate 74, thus outputting signal C in bus 75, C being the minimum of both values of signals A and B, encoded temporally. Finally, the result of the selection of the minimum (i.e., signal C in bus 75) may be encoded back to a binary signal 77 by using a TDC 76.

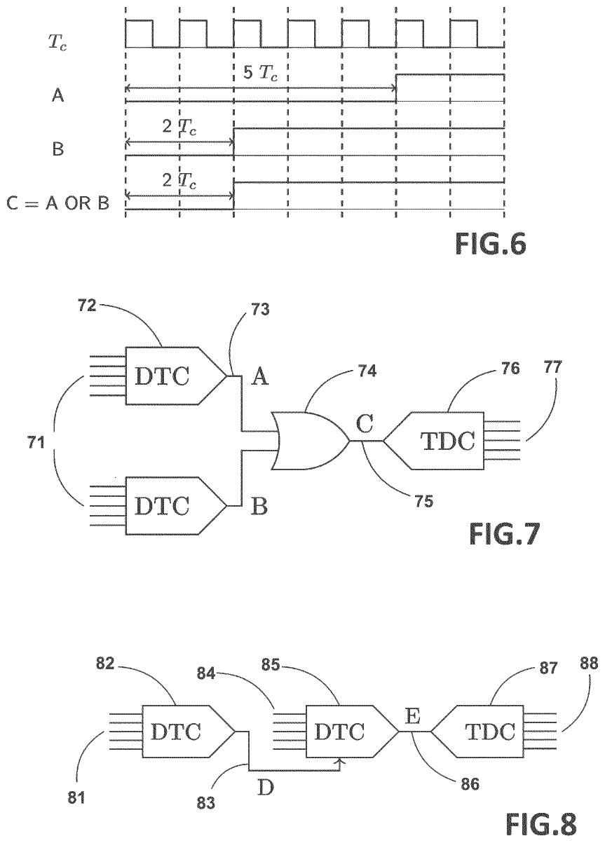

FIG. 6 shows an example of such coding of the DTC wherein the fixed period of time is seven clock cycles (i.e., 7×T_{c}), and therefore, P=3 (i.e., the input signal may be encoded with 3 bits). When converting a signal of value A=5 (i.e., binary signal “101”) to its temporal equivalent, in the first clock cycle T_{c}, the counter is at 0, and therefore the output of the DTC may be 0 unless the binary number to be encoded is 0 (because the output is 0 when the number to be temporally encoded is less than the number the counter is at). When the sixth clock cycle arrives (after T=5T_{c}, five clock cycles have passed), the counter is at 5, and the output of the DTC becomes 1.

In the same figure another example is shown, for a signal of value B=2, when the third clock cycle arrives (after T=2T_{c}, two clock cycles have passed), the counter is at 2, and the output of the DTC becomes 1.

In the case of the TDC, its output is the result of counting how many clock cycles the 1-bit input signal is at the low state (in this example, 0).

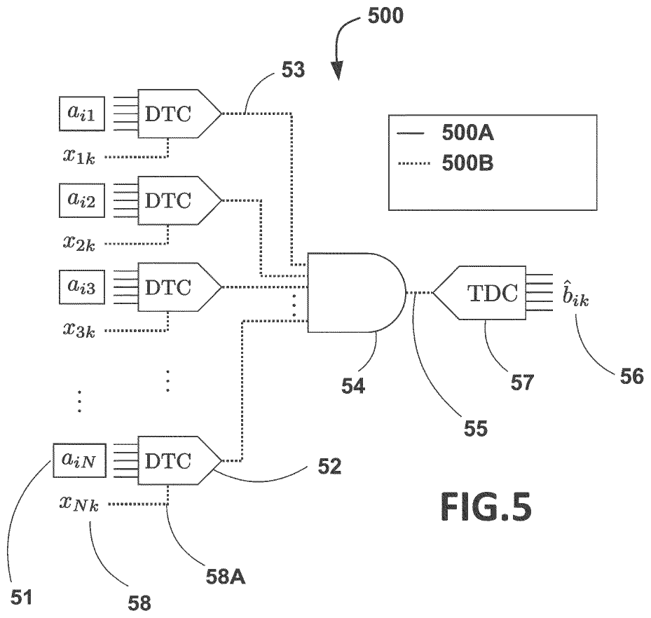

As shown in FIG. 6, with the previously described implementation of the encoding performed by the DTC, in order to perform a selection of a minimum value among two or more temporal signals (i.e., in example of FIG. 5, signals A and B), an OR logic gate may be used. This gate may always deliver the minimum, regardless of the values of the signals compared, i.e., inputted in the OR gate. This way, the bus 35, receives all the results of the sums in L bits, each bit being temporally encoded, the bus being inputted into an OR gate array 36, in order to select the local minimum value among all the values carried by the L bits of bus 35. Therefore, the output of each OR gate of the array 36 is the local minimum value among each corresponding addition vector. Such outputs are still temporally encoded, and therefore, they may be decoded back to binary signals using an array of TDCs 38, thus generating, at the output of each TDC, each weight 39 corresponding the the k^{th} column of the weight matrix X̅.

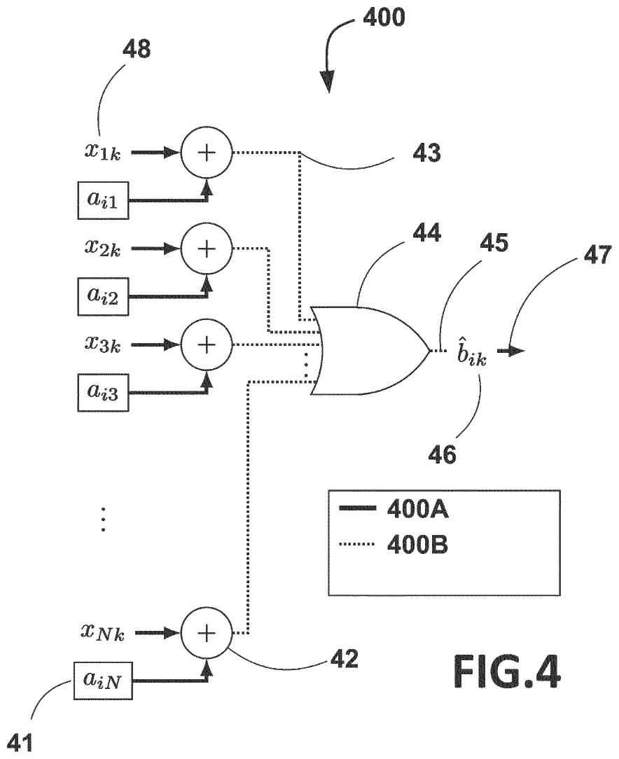

FIG. 4 depicts an example of the inference 400 of the neural network after being trained by using the method of training described in the embodiment depicted of FIG. 2. More precisely, FIG. 4 shows the weights x̅ᵢₖ 48 (the N weights, from x̅₁ₖ to x̅_{Nk}) of the k^{th} column of matrix X̅ of weights, the matrix of weights being obtained by the training performed by the integrated circuit chip apparatus depicted in FIG. 2. In FIG. 4, continuous thick lines 400A depict traditional binary encoded buses (carrying binary encoded signals of n bits, in case no overflow in the previously performed operations occurs, in which case n would be increased by one or more bits, as needed because of the overflow), and dotted lines 400B depict stochastically encoded one-bit buses (carrying stochastically encoded signals, and the bus carrying one bit only).

Furthermore, new inputs for the neural network \vec{a}ᵢ vector 41 (the N new inputs, from aᵢ₁ to a_{iN}, in a given discretized time “i”), are depicted, which, in order to perform the inference, are operated using the linear regression operation used for the inference, according to the present disclosure, previously mentioned in the embodiment of the training depicted in FIG. 2. Such linear regression may be expressed by:

\hat{b}ᵢⱼ=⊕(aᵢₙ⊗x̅ₙⱼ)=max(aᵢ₁+x̅₁ⱼ,aᵢ₂+x̅₂ⱼ, . . . ,a_{iN}+x̅_{Nj})

This inference is related to the training performed to obtain the weights of the neural network, and, in this example, depends on the encoding of the addition vectors into stochastic signals and the selection of the minimum previously performed in the training. Therefore, a first matrix addition of a column of the matrix of weights X̅ and the vector \vec{a}ᵢ (comprising aᵢ₁ to a_{iN} inputs) is performed, using an adder digital circuit, more precisely, an array of binary digital adders 42. In this particular example, a stochastic encoder is coupled to each output of each sum of the array of binary digital adders 42, thus encoding the output signal of each sum of the array 42 into a stochastic signal in a bus 43. Therefore, the output of each sum is a single bit bus 43 (which, after the encoder, carries a stochastic signal), which may be inputted in an OR logical gate, in order to select the maximum among all values carried by each bus 43. In this case, a maximum is selected in the present inference, because a minimum has been previously selected when performing the training method.

Therefore, after selecting the maximum, the result is obtained stochastically encoded 45, and is decoded into a traditional binary signal 47, thus outputting value bᵢₖ 46 encoded in a traditional binary signal 47. In this example, \hat{b}ᵢₖ is a component of an output vector, wherein i is the discretized time “i” of the input used to obtain said output vector, and k being the specific output among the possible outputs of the neural network against which the network has been trained.

FIG. 5 depicts a further example of the inference of the neural network after being trained by using the method of training described in the embodiment depicted of FIG. 3. More precisely, FIG. 5 shows the weights x̅ᵢₖ 58 (the N weights, from x̅₁ₖx₁ₖ to x̅_{Nk}) of the k^{th} column of matrix X̅ of weights, the matrix of weights being obtained by the training performed by the integrated circuit chip apparatus depicted in FIG. 3. In FIG. 5, continuous lines 500A depict traditional binary encoded buses (carrying binary encoded signals of n bits), and dotted lines 500B depict temporally encoded one-bit buses (carrying temporally encoded signals, and the bus carrying one bit only).

Furthermore, new inputs for the neural network \vec{a}ᵢ vector 51 (the N new inputs, from aᵢ₁ to a_{iN}, in a given discretized time “i”), are depicted, which, in order to perform the inference, are operated using the linear regression operation used for the inference, according to the present disclosure, previously mentioned in the embodiment of the training depicted in FIG. 3. Such linear regression may be expressed by:

\hat{b}ᵢⱼ=⊕(aᵢₙ⊗x̅ₙⱼ)=max(aᵢ₁+x̅₁ⱼ,aᵢ₂+x̅₂ⱼ, . . . ,a_{iN}+x̅_{Nj})

This inference is related to the training performed to obtain the weights of the neural network, and, in this example, depends on the encoding of the addition vectors into temporal signals and the selection of the minimum previously performed in the training.

In this example, weights x̅ᵢₖ 58 are already temporally encoded and the vector \vec{a}ᵢ is encoded in traditional binary. Furthermore, a temporal encoding of the vector \vec{a}ᵢ is performed, and, simultaneously, a matrix addition of a column of the matrix of weights X̅ and the temporally encoded vector \vec{a}ᵢ (comprising aᵢ₁ to a_{iN} inputs) is performed. Such operations are performed by using a DTC circuit arrangement 52, by connecting each x̅ᵢₖ 58 to the corresponding DTC.

The temporal encoding of the vector \vec{a}ᵢ and the matrix addition are performed by the DTC circuit arrangement 52. FIG. 8 depicts an example of a circuit arrangement to perform such operations. More specifically, FIG. 8 depicts an example of an addition of two binary quantities 81 and 82, wherein a first quantity to be added 81 may be converted to a temporal signal 83 (in the case of x̅ᵢₖ 58, the signals are already temporally encoded), by using a first DTC device 82. The resulting temporally encoded 1-bit signal 83 may be used to block the upward count performed by the counter of a second DTC device 85, thus, at the end of the count-up time, the output 86 resulting in a temporal equivalent to the sum of the two input values 81 and 84. Finally, the result of the counting 86 may be encoded back to a binary signal 88 by using a TDC 87 as previously described.

FIG. 9 shows an example of such coding of the DTC 85 wherein the fixed period of time is seven clock cycles (i.e., 7×T_{c}). When adding a signal of value D=4 (binary signal 81 temporally encoded, i.e., signal 83 in FIG. 8) with a signal of value E=2 (binary signal 84), in the first four clock cycles T_{c} (4 T_{c}), the counter is at 0, and therefore the output of the DTC (which is signal E, while being calculated) may be 0 unless the binary number to be encoded is 0. That is, the output of a DTC is 0 while the number to be encoded is less than the number the counter is counting. When the fifth clock cycle arrives (after T=4T_{c}, four clock cycles have passed), the counter starts counting, thus the counter is at 0. When the seventh clock cycle arrives (after T=6T_{c}, six clock cycles have passed), the counter is at 2, and the output of the DTC (signal E) becomes 1. Therefore, the total temporal count of clock cycles equals to 6, which is the sum of D (4) and E (2), temporally encoded.

Therefore, the temporal encoding of the vector \vec{a}ᵢ and the matrix addition are performed by the DTC 52 using the circuit arrangement shown in the example of FIG. 9, thus outputting each bus 53 with the corresponding sum of each element of vector \vec{a}ᵢ and each element of the column of matrix X̅.

Alternatively, the previously described sum of a column of the matrix of weights X̅ and vector \vec{a}ᵢ may be performed by decoding the weights from temporal coding to binary code, and further performing the sum by means of an adder digital circuit, such as an array of binary digital adders. This way, the output of each sum may be encoded in traditional binary code and may further be converted into a temporal signal (by using, for example, a DTC), outputting, for each bus 53, the result of each sum temporally encoded.

Therefore, the output of each sum is a single bit bus 53 (which carries a temporal signal), which may be inputted in an AND logical gate, in order to select the maximum among all values carried by each bus 53. In this case, a maximum is selected in the present inference, because a minimum has been previously selected when performing the training method.

Therefore, after selecting the maximum, the result is obtained temporally encoded 55, and is decoded into a traditional binary signal 56, by using a TDC 57, thus outputting value \hat{b}ᵢₖ 56 in binary code. In this example, \hat{b}ᵢₖ is a component of an output vector, wherein i is the discretized time “i” of the input used to obtain said output vector, and k being the specific output among the possible outputs of the neural network against which the network has been trained.

The advantage of a temporal encoding over stochastic coding is the absence of stochastic noise.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

1. Method of non-iterative training of a neural network performed by an electronic system, based on training data including an input data matrix and an output data matrix, the output data matrix being expected for said input data matrix, wherein the output data matrix comprises a plurality of output vectors corresponding to each column of the output data matrix, the training resulting in a matrix of weights of the neural network, and wherein the method comprises the steps of:
a) Transposing the input data matrix;
b) Negating the elements within the transposed input data matrix;
c) Selecting a plurality of input vectors corresponding to each row of the transposed and negated input data matrix;
d) Generating a matrix of addition vectors, wherein each addition vector is the sum of:
the input vector corresponding to the row of the input data matrix, said row corresponding to the row position of the addition vector; and
the output vector corresponding to the column of the output data matrix, said column corresponding to the column position of the output vector;
e) Selecting, for each addition vector, a maximum or minimum value among the elements of the addition vector;
f) Generating a matrix of weights for the neural network, wherein each weight of the matrix is the selected maximum or minimum value of the vector found in the same position of the matrix of addition vectors as the position of the weight within the matrix of weights.

2. Method of non-iterative training of a neural network according to claim 1, wherein selecting, for each addition vector, a maximum or minimum value comprises selecting for all the addition vectors the respective maximum value.

3. Method of non-iterative training of a neural network according to claim 1, wherein selecting, for each addition vector, a maximum or minimum value comprises selecting for all the addition vectors the respective minimum value.

4. Method of non-iterative training of a neural network according to any of claims 1 to 3, wherein the apparatus comprises an adder digital circuit and a comparison digital circuit, wherein:
the input data matrix comprises L rows and N columns, the input data matrix corresponding to a single input training data set of samples used to train the neural network;
the output data matrix comprises L rows and K columns, the output data matrix corresponding to a desired output training data set used to train the neural network, the desired output training data set being paired with the single input training data set;
wherein the elements of the input data matrix and the desired output data matrix; numbers L, N and K are natural numbers, N being the amount of neurons to be trained of the neural network, K being the number of possible outputs to be trained of the neural network, and L being the number of samples used to train the neural network; and wherein the steps a) to e) further comprise the following steps:
for each neuron j of the neural network, wherein j is a natural number, and 1=<j=<N:
for each output k of the neural network, wherein k is a natural number and is 1=<k=<K, performing the steps of:
negating the elements of column j of the input data matrix;
generating an addition vector by performing a matrix addition of column k of the desired output data matrix with the previously negated column j of the input data matrix, the matrix addition being performed by the adder digital circuit;
generating a weight x̅ⱼₖ by selecting an element among all the elements of the previously obtained addition vector, the selected element being either the maximum or the minimum value among all values of each element of the addition vector, the selection being performed by the comparison digital circuit;
generating a weight vector \overline{\vec{x}}ⱼ comprising all the generated weights x̅ⱼₖ for the neuron j;
and wherein step f) further comprises:
generating a weight data matrix comprising, for each row corresponding to each neuron j, the corresponding weight vector \overline{\vec{x}}ⱼ, wherein the weight data matrix has N rows and K columns.

5. Method of non-iterative training of a neural network according to any of claims 1 to 4, wherein at least one generated addition vector is embedded in a digital signal comprising a data vector resulting from a Digital temporal encoding.

6. Method of non-iterative training of a neural network according to claim 5, when it depends on claim 3, wherein the comparison digital circuit comprises one or more OR logic gates.

7. Method of non-iterative training of a neural network according to any of claims 1 to 4, wherein at least one generated addition vector is embedded in a signal comprising a data vector resulting from a Digital stochastic encoding.

8. Method of non-iterative training of a neural network according to claim 7, when it depends on claim 3, wherein the comparison digital circuit comprises one or more AND logic gates.

9. Electronic system for non-iterative training of a neural network, based on training data including an input data matrix and an output data matrix, the output data matrix being expected for said input data matrix, wherein the output data matrix comprises a plurality of output vectors corresponding to each column of the output data matrix, the training resulting in a matrix of weights of the neural network, and wherein the system comprises:
A transposing module configured to transpose the input data matrix;
A negating module configured to negate the elements within the transposed input data matrix;
A first selecting module configured to select a plurality of input vectors corresponding to each row of the transposed and negated input data matrix;
A matrix generation module configured to generate a matrix of addition vectors, wherein each addition vector is the sum of:
the input vector corresponding to the row of the input data matrix, said row corresponding to the row position of the addition vector; and
the output vector corresponding to the column of the output data matrix, said column corresponding to the column position of the output vector;
A second selecting module configured to select, for each addition vector, a maximum or minimum value among the elements of the addition vector;
An output module configured to generate a matrix of weights for the neural network, wherein each weight of the matrix is the selected maximum or minimum value of the vector found in the same position of the matrix of addition vectors as the position of the weight within the matrix of weights.

10. An electronic system according to claim 9, wherein the matrix generation module comprises an array of binary digital adders to perform the sum of the addition vectors.

11. An electronic system according to any of claim 9 or 10, wherein the system further comprises at least one stochastic encoder to encode at least one addition vector.

12. An electronic system according to any of claims 9 to 11, wherein the system further comprises at least one temporal encoder to encode at least one addition vector.

13. An electronic system according to any of claims 9 to 12, wherein the second selection module comprises a comparison digital circuit, which comprises:
An OR logic gate, if the addition vectors to be compared are temporally encoded, and a minimum is selected; or
An AND logic gate, if the addition vectors to be compared are stochastically encoded, and a minimum is selected.

14. An electronic system according to any of claims 9 to 13, wherein the input data matrix comprises data related to a sound signal, the generated matrix of weights describes features of the sound signal, and wherein the matrix of weights is used to generate a prediction of the sound signal over time.

15. An electronic system according to any of claims 9 to 14, further embedded in a single integrated circuit chip apparatus.

16. An electronic system according to any of claims 9 to 15, further comprising an inference module configured to infer the trained neural network, the inference being based on inference data including an inference input data matrix and the generated matrix of weights, the inference module comprising:
A first selecting module configured to select a plurality of inference input vectors corresponding to each row of the inference input data matrix;
A second selecting module configured to select a plurality of inference vectors corresponding to each column of the matrix of weights;
A matrix generation module configured to generate a matrix of inference addition vectors, wherein each inference addition vector is the sum of:
the inference input vector corresponding to the row of the inference input data matrix, said row corresponding to the row position of the inference addition vector; and
the inference vector corresponding to the column of the matrix of weights, said column corresponding to the column position of the inference addition vector;
A third selecting module configured to select, for each inference addition vector, a maximum or minimum value among the elements of the inference addition vector;
An output module configured to generate a matrix of inferred outputs for the neural network, wherein each elements of the matrix is the selected maximum or minimum value of the inference vector found in the same position of the matrix of inference addition vectors as the position of the inferred output within the matrix of inferred output.

17. An electronic system according to claim 16, wherein the third selecting module selects, for each inference addition vector:
a maximum, if the weights of the inference vector have been generated by selecting a minimum value within the corresponding addition vector, by the second selecting module of the electronic system of claim 9; and
a minimum, if the weights of the inference vector have been generated by selecting a maximum value within the corresponding addition vector, by the second selecting module of the electronic system of claim 9.

18. An electronic system according to claim 17, wherein the third selecting module of the inference module comprises a comparison digital circuit to perform the selection of a maximum or a minimum, and wherein the comparison digital circuit comprises:
An OR logic gate, if the third selecting module selects a maximum and the inference addition vector is stochastically encoded; or
An AND logic gate, if the third selecting module selects a maximum and the inference addition vector is temporally encoded.
